(19) United States
(12) Patent Application Publication
(10) Pub. No.: US 2009/0049533 A1
(43) Pub. Date: Feb. 19, 2009

(54) USER AUTHENTICATION METHOD AND APPARATUS

(75) Inventor: Byoung-yue KIM, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/173,128

(22) Filed: Jul. 15, 2008

(30) Foreign Application Priority Data
Aug. 17, 2007 (KR) 2007-83017

(51) Int. Cl. H04L 9/32

(52) U.S. Cl. 726/7

(57) ABSTRACT

A user authentication method and apparatus, the user authentication method including: performing a user authentication using user information transmitted by a host through a protocol supporting user authentication; generating user authentication information from the transmitted user information if the user authentication is performed successfully; and determining whether a service requested from the host using a protocol that does not support user authentication is permitted by using the generated user authentication information. Thus, the method can be used to selectively provide a service even when a service using a protocol that does not support user authentication is requested.

### CROSS-REFERENCE TO RELATED APPLICATION

This application claims the benefit of Korean Application No. 2007-83017, filed Aug. 17, 2007 in the Korean Intellectual Property Office, the disclosure of which is incorporated herein by reference.

### BACKGROUND OF THE INVENTION

1. Field of the Invention

Aspects of the present invention relate to a user authentication method and apparatus, and more particularly, to a user authentication method and apparatus for providing a service using a protocol that does not support user authentication.

2. Description of the Related Art

Network printers perform printing through a network by using a protocol that does not support user authentication (such as a standard TCP/IP printing protocol, line printing daemon (LPD), etc.). Accordingly, it is difficult to selectively provide a printing service by identifying a user in such network printers.

A method disclosed in Korean Patent Publication No. 2001-0027817 overcomes the above problem by using an IP filtering method. FIG. 1 is a block diagram for describing a conventional method in which a printing service is selectively provided by identifying a user. Referring to FIG. 1, IP addresses of a first host 110 and a second host 120, to which printing services are to be provided, are previously registered in a printer 100. When the printer 100 receives requests for printing services from the first host 110, the second host 120, and a third host 130, the printer 100 can provide the printing services to the first host 110 and the second host 120, and can reject the printing service to the third host 130 since the printer 100 can selectively print only data provided from a host having an IP address registered in the printer 100.

However, in the conventional IP filtering method, a strategy for an IP should be previously set in a static manner, and should be updated for a new IP. In addition, when a user uses a current or dynamic IP, it is difficult to use the IP filtering method.

### SUMMARY OF THE INVENTION

Aspects of the present invention provide a user authentication method and apparatus for selectively providing a service by identifying a user even when the service uses a protocol that does not support user authentication.

Aspects of the present invention also provide a computer-readable medium storing a program for performing the method in a computer.

According to an aspect of the present invention, there is provided a user authentication method including: performing a user authentication using user information transmitted by a host through a protocol supporting user authentication; generating user authentication information from the transmitted user information if the user authentication is performed successfully; and determining whether a service requested from the host using a protocol that does not support user authentication is permitted by using the generated user authentication information.

According to another aspect of the present invention, there is provided a computer-readable medium recording a program for performing the above method in a computer.

According to yet another aspect of the present invention, there is provided a user authentication apparatus including: an interface unit to connect to a host through a network; a user authentication unit to perform a user authentication using user information received from the host through a protocol supporting user authentication; an authentication information generating unit to generate user authentication information from the transmitted user information if the user authentication is performed successfully; and a service managing unit to determine whether a service requested from the host using a protocol that does not support user authentication is permitted by using the generated user authentication information.

According to still another aspect of the present invention, there is provided a system for performing a user authentication, the system including: a host to transmit user information through a protocol supporting user authentication and to transmit data including a service request and an IP address of the host through a protocol that does not support user authentication; and a user authentication apparatus including: an interface unit to connect to the host through a network, to receive the user information transmitted from the host through the protocol supporting user authentication, and to receive the data including the service request transmitted from the host through the protocol that does not support user authentication; a user authentication unit to perform a user authentication using the user information received from the host through the protocol supporting user authentication; an authentication information generating unit to generate user authentication information from the received user information if the user authentication is performed successfully; and a service managing unit to determine whether the service request received from the host is permitted by using the generated user authentication information.

According to another aspect of the present invention, there is provided a user authentication method for an image forming apparatus, the method including: performing a user authentication using user information transmitted by a host through a protocol supporting user authentication; generating user authentication information from the transmitted user information if the user authentication is performed successfully; and determining whether a service requested from the host is permitted by using the generated user authentication information.

According to another aspect of the present invention, there is provided a user authentication apparatus for an image forming apparatus, the user authentication apparatus including: an interface unit to connect to a host through a network; a user authentication unit to perform a user authentication using user information received from the host through a protocol supporting user authentication; an authentication information generating unit to generate user authentication information from the transmitted user information if the user authentication is performed successfully; and a service managing unit to determine whether a service requested from the host is permitted by using the generated user authentication information.

The host may transmit the user information together with the data including the service request and the IP address of the host.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram for describing a conventional method in which a printing service is selectively provided by identifying a user;

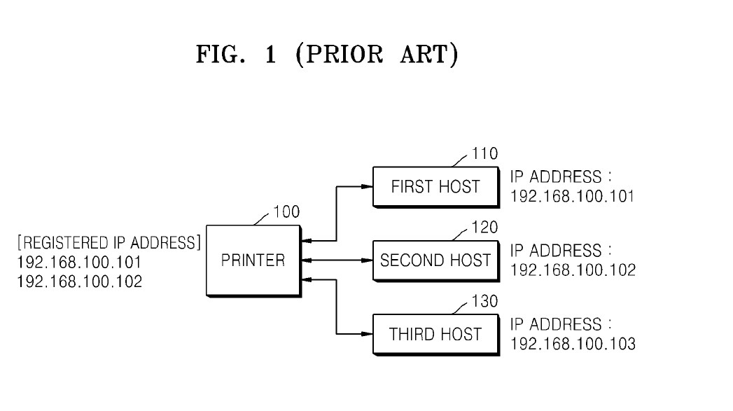

FIG. 2 is a block diagram of a user authentication system according to an embodiment of the present invention;

FIGS. 3A and 3B are views for describing examples of how a printing apparatus illustrated in FIG. 2 manages authentication information according to an embodiment of the present invention;

FIG. 4 is a flowchart of a user authentication method using the user authentication system of FIG. 2 according to an embodiment of the present invention;

FIG. 5 is a flowchart in illustrating an operation of the user authentication method of FIG. 4 according to an embodiment of the present invention;

FIG. 6 is a flowchart illustrating an operation of the user authentication method of FIG. 4 according to an embodiment of the present invention; and

FIG. 7 is a structural view for describing the user authentication method of FIG. 4 according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

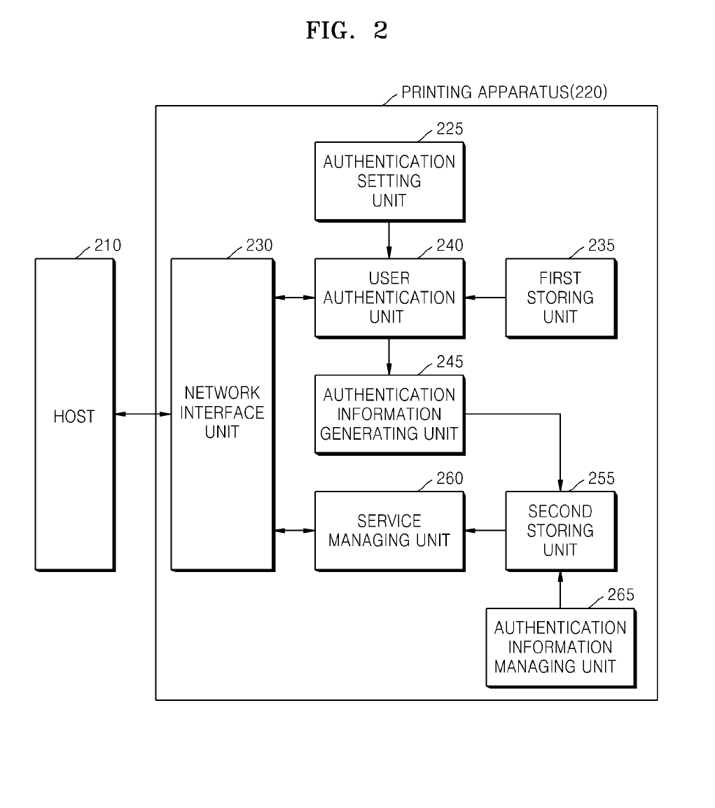

FIG. 2 is a block diagram of a user authentication system according to an embodiment of the present invention. Referring to FIG. 2, the user authentication system includes a host 210 and a printing apparatus 220. The printing apparatus 220 includes an authentication setting unit 225, a network interface unit 230, a first storing unit 235, a user authentication unit 240, an authentication information generating unit 245, a second storing unit 255, a service managing unit 260, and an authentication information managing unit 265.

The host 210 transmits a first packet that includes user information (such as a user ID, a password, etc.) and an IP address of the host 210 to the printing apparatus 220 by using a protocol supporting user authentication. The protocol supporting user authentication is a general-purpose protocol, such as a hypertext transfer protocol (HTTP) that is a protocol of the world wide web (WWW) server, a file transfer protocol (FTP), etc.

When the printing apparatus 220 receives the first packet from the host 210, the printing apparatus 220 detects the user information and the IP address of the host 210 from the first packet, and performs user authentication by using the detected user information. Specifically, the user authentication is performed by checking whether the detected user information is included in user information that has been previously stored in the printing apparatus 220.

When the user authentication is successful, the printing apparatus 220 generates user authentication information including the user ID, the IP address of the host 210, and a plurality of permissible service items or functions.

The host 210 transfers a second packet that includes the IP address of the host 210 and data for providing a service to the printing apparatus 220. The host 210 may transfer the second packet by using a protocol that does not support user authentication (such as a Standard TCP/IP Printing protocol, a line printing daemon (LPD) protocol, etc.). The data for providing a service is data required for performing the service. For example, if the service is a printing service, the data is printing data. Similarly, if the service is for setting and managing the printing apparatus 220, the data is predetermined data corresponding to the service. Hereinafter, the data for providing a service is referred to as service data.

When the printing apparatus 220 receives the second packet from the host 210, the printing apparatus 220 detects the IP address of the host 210 and the service data from the second packet. When it is confirmed that the detected IP address of the host 210 is included in the generated user authentication information, and the service requested according to the detected service data is one of the permissible service items of the generated user authentication information, the printing apparatus 220 permits the requested service.

A structure of the printing apparatus 220 illustrated in FIG. 2 will now be described in more detail. The authentication setting unit 225 sets the printing apparatus 220 to perform user authentication according to aspects of the present invention. The network interface unit 230 receives the first packet including the user information (for example, the user ID, the password, etc.) and the IP address of the host 210 from the host 210 by using the protocol supporting user authentication. Then, the network interface unit 230 transmits a message regarding success or failure of the user authentication, which is generated by the user authentication unit 240. As described above, the protocol supporting user authentication is a general-purpose protocol (such as HTTP, FTP, etc.).

The first storing unit 235 stores a user information table that the user authentication unit 240 uses to perform user authentication. The user information table is previously generated by an administrator of the printing apparatus 220, and includes user information (such as the user ID and the password), and permissible service items. In this case, the permissible service items are service items permitted according to the user ID, which are requested using a protocol that may not support user authentication (e.g., LPD protocol, Standard TCP/IP Printing protocol, or the like). For example, in an LPD service, a document that is provided from the host 210 is received using a line printer remote (LPR) service.

The user authentication unit 240 detects the user information and the IP address of the host 210 from the first packet that is received from the host 210. The user authentication unit 240 performs user authentication by comparing the detected user information to the user information table that is stored in the first storing unit 235. For example, the user authentication unit 240 determines whether the detected user ID and password respectively correspond to a user ID and a password in the user information table. Then, if the detected user ID and password respectively correspond to a user ID and a password in the user information table, the user authentication unit 240 deems the user authentication to be successful, and transmits a user authentication success message through the network interface unit 230 to the host 210. When the user authentication performed by the user authentication unit 240 is successful, the authentication information generating unit 245 generates the user authentication information including, for example, the user ID, the IP address of the host 210, and the permissible service items according to the user ID.

The second storing unit 255 stores the user authentication information generated by the authentication information generating unit 245. The stored user authentication information is provided to the service managing unit 260, and is used to determine whether the requested service is to be permitted.

The network interface unit 230 receives the second packet including the IP address of the host 210 and the service data from the host 210 by using a protocol that may not support user authentication. As described above, the protocol may be a Standard TCP/IP Printing protocol, line printing daemon (LPD) protocol, etc. The service data is data used to perform the service.

The service managing unit 260 detects the IP address of the host 210 and the service data from the second packet received from the host 210, and checks whether the detected IP address of the host 210 is included in the user authentication information stored in the second storing unit 255. Then, when it is confirmed that the detected IP address is included in the user authentication information, the service managing unit 260 determines whether the service data corresponds to services permitted for the user. For example, when the service managing unit 260 receives LPD service data from the host 210, if the IP address of the host 210 corresponds to an IP address that is included in the user authentication information and an LPD service is one of the permissible service items according to the IP address, the service managing unit 260 determines that the LPD service is permitted.

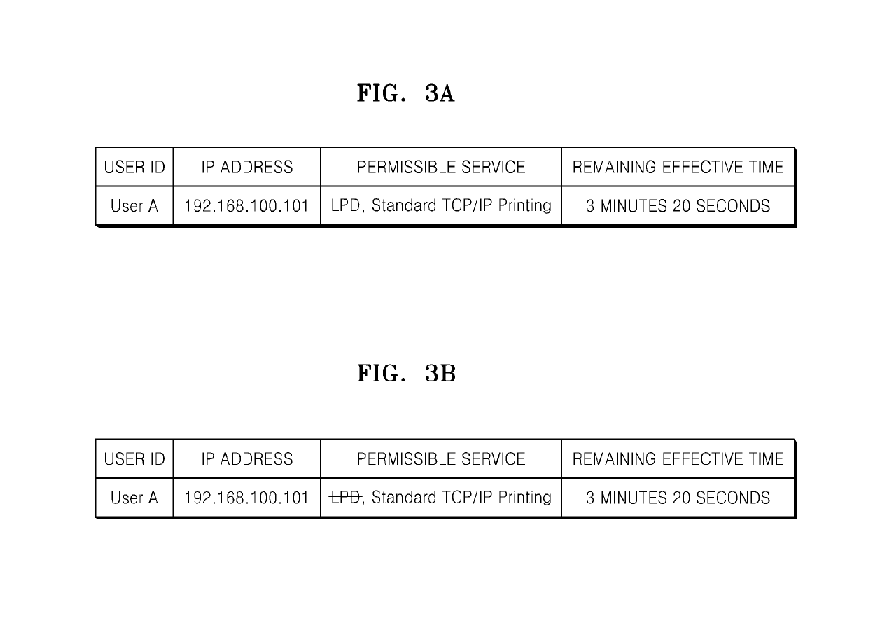

The authentication information managing unit 265 manages the user authentication information stored in the second storing unit 255. As an example, as shown in FIG. 3A, when a predetermined time elapses after the generation of the user authentication information, the authentication information managing unit 265 may automatically remove the user authentication information. As another example, as shown in FIG. 3B, according to a selection indicating that a used service item of the user authentication information is to be removed, the authentication information managing unit 265 removes a service that has already been provided from the permissible service items. Thus, to use the already provided service again, the printing apparatus 220 may perform the user authentication again.

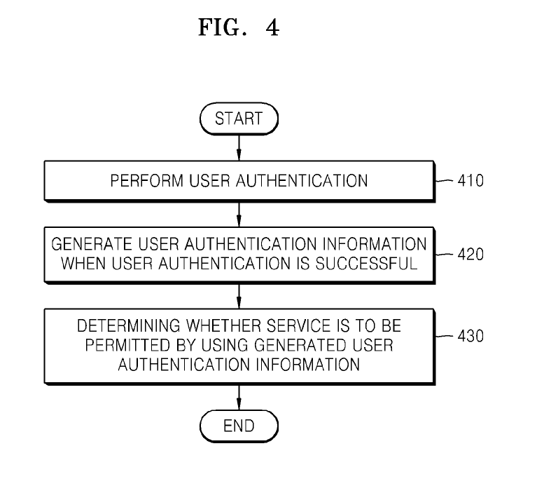

FIG. 4 is a flowchart of a user authentication method using the user authentication system of FIG. 2 according to an embodiment of the present invention. Referring to FIG. 4, in operation 410, the printing apparatus 220 receives a first packet that includes user information (such as a user ID, a password, etc.) and an IP address of the host 210 from the host 210 by using a general-purpose protocol that supports user authentication. Accordingly, the printing apparatus 220 performs user authentication based on the user information.

In operation 420, when the user authentication is successful, the printing apparatus 210 generates user authentication information including the user information (such as the user ID), the IP address of the host 210, and the permissible service items. When a predetermined time elapses after the generation of the user authentication information, the user authentication information may be removed. In this case, when a predetermined time elapses after the printing apparatus 210 succeeds in user authentication, the user authentication may be performed again if the host 210 requests a service from the printing apparatus 210.

In operation 430, the printing apparatus 220 receives a second packet including the IP address of the host 210 and service data from the host 210 by using a protocol that may not support user authentication. Then, the printing apparatus 220 determines a service to be permitted by comparing the received IP address and service data with the user authentication information generated in operation 420.

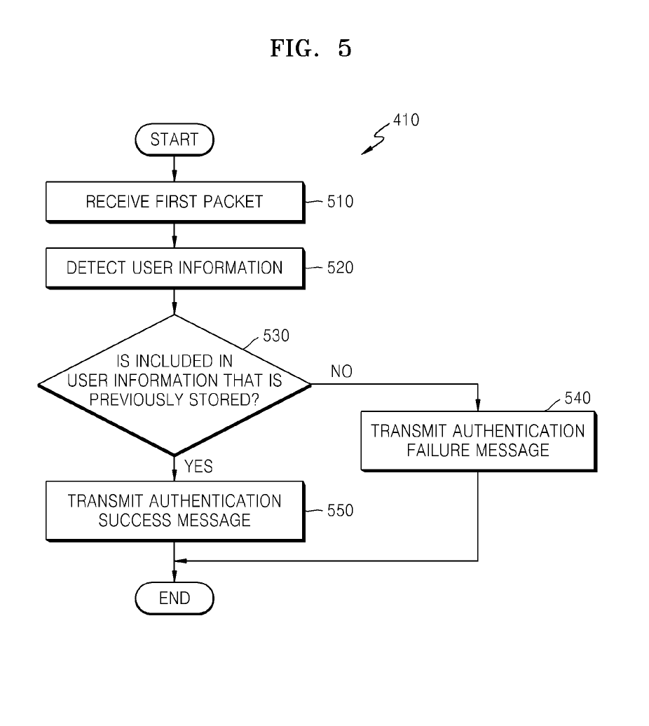

FIG. 5 is a flowchart illustrating operation 410 of the user authentication method illustrated in FIG. 4 according to an embodiment of the present invention. Referring to FIG. 5, in operation 510, the printing apparatus 220 receives the first packet that includes the user information (such as the user ID, the password, etc.) and the IP address of the host 210 from the host 210 by using a general-purpose protocol (e.g., HTTP, FTP, etc.) that supports user authentication. In operation 520, the printing apparatus 220 detects the user information and the IP address of the host 210 from the first packet received in operation 510.

In operation 530, the printing apparatus 220 checks whether the received user information (operation 520) respectively corresponds to previously stored user information. The user information may be previously generated by an administrator of the printing apparatus 220, and is stored in the printing apparatus 220. For example, the user information may include the user ID, the password, and the permissible service items. In this case, the permissible service items are service items permitted according to the user ID, which are requested using a protocol that may not support user authentication (e.g., LPD, Standard TCP/IP Printing protocol, or the like). It is understood that, according to other aspects, the previously stored user information may be stored in an external storage device (such as a network server or administrative apparatus).

If it is determined that the received user information (operation 520) does correspond to the previously stored user information (operation 520), the printing apparatus 220 deems the user authentication to have failed, and generates a user authentication failure message to be transmitted to the host 210 in operation 540.

If it is determined that the received user information (operation 520) corresponds to the previously stored user information (operation 520), the printing apparatus 220 deems the user authentication to be successful, and generates a user authentication success message to be transmitted to the host 210 in operation 550.

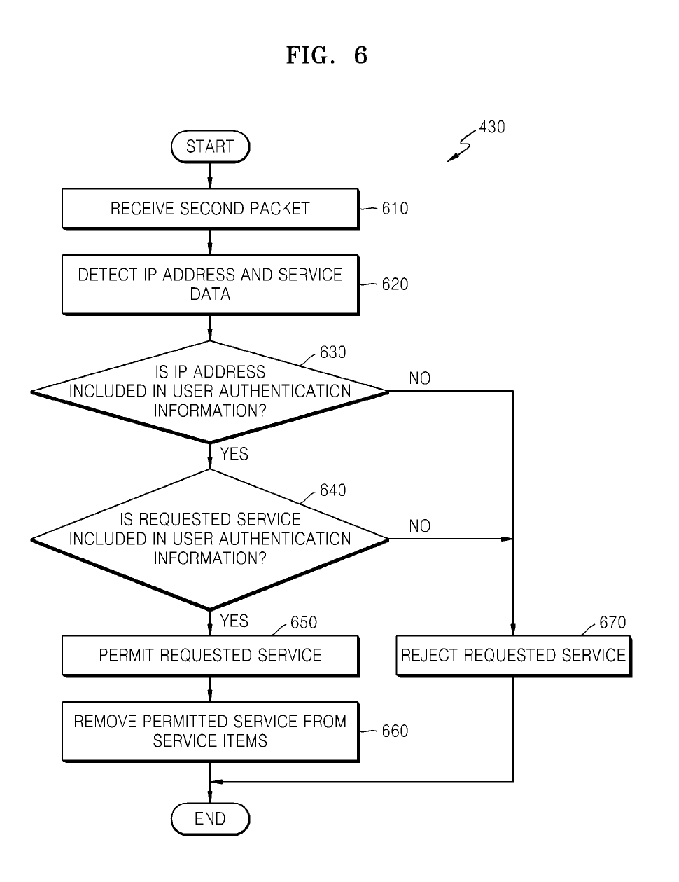

FIG. 6 is a flowchart illustrating operation 430 of the user authentication method illustrated in FIG. 4 according to an embodiment of the present invention. Referring to FIG. 6, in operation 610, the printing apparatus 220 receives the second packet including the IP address of the host 210 and the service data from the host 210 by using a protocol that may not support user authentication. Protocols that do not support user authentication include a Standard TCP/IP Printing protocol, LPD protocol, etc. Data for providing the service is data used to perform the service. For example, if the service is a printing service, the data is printing data, and if the service is for setting and managing the printing apparatus 220, the data is predetermined data corresponding to the service.

In operation 620, the printing apparatus 220 detects the IP address of the host 210 and the service data from the second packet received in operation 610. Then, in operation 630, the printing apparatus 220 checks whether the IP address detected in operation 620 is included in the user authentication information. If the IP address is not included in the user authentication information (operation 630), the printing apparatus 220 rejects the required service operation 670.

However, if the IP address is included in the user authentication information (operation 630), the printing apparatus 220 determines whether a service corresponding to the service data is included in the user authentication information in operation 640. Accordingly, if the required service is not included in the user authentication information (operation 640), the printing apparatus 220 rejects the required service in operation 670.

If it is determined that the required service is included in the user authentication information (operation 640), the printing apparatus 220 permits the required service. As an example, if the required service is a printing service using an LPD service, the printing apparatus 220 starts printing by using the LPD service.

In operation 660, the printing apparatus 220 removes the service permitted in operation 650 from the permissible service items of the user authentication information. Thus, to use the service that has been provided again, the user authentication is again carried out by performing operation 410 (FIG. 4). However, it is understood that according to other aspects, the permitted service is maintained in the permissible service items.

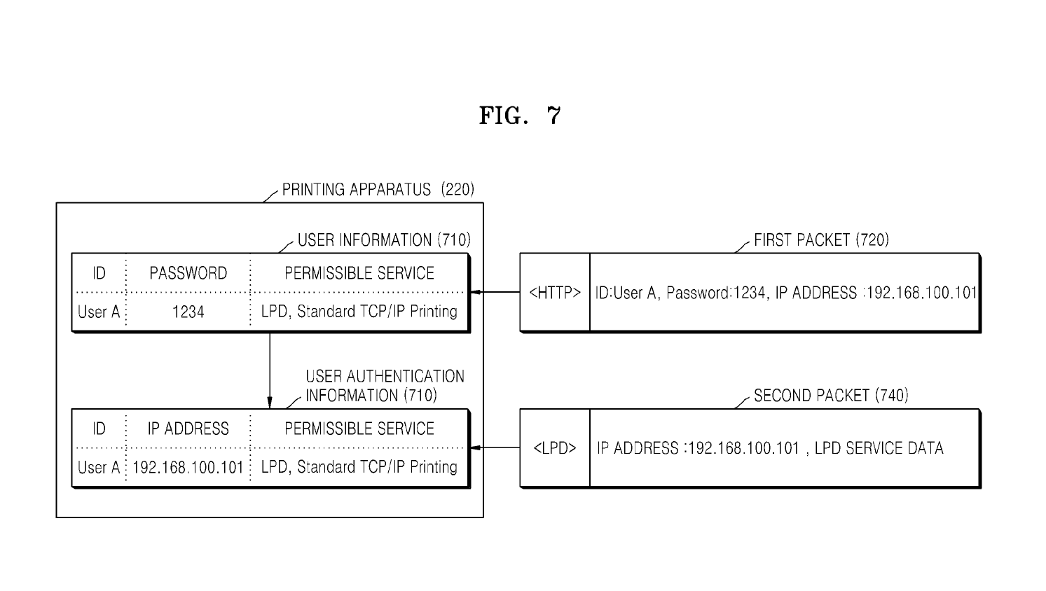

FIG. 7 is a structural view for describing the user authentication method of FIG. 4 according to an embodiment of the present invention. Referring to FIG. 7, first, the printing apparatus 220 receives user information 710 including an ID (UserA), a Password (1234), and a permissible service (LDP, Standard TCP/IP Printing from an administrator), and stores the user information 710.

The printing apparatus 220 receives a first packet 720 including the ID (User A), the Password (1234), and the IP address (192.168.100.101) from the host 210 by using the HTTP protocol.

The printing apparatus 220 checks whether the ID (UserA) and the Password (1234) of the first packet 720 are included in the user information 710.

As a result of the check, since the ID (UserA) and the Password (1234) are included in the user information 710, the printing apparatus 220 generates user authentication information 730 including the ID (UserA), the IP address (192.168.100.101), and the permissible service (LDP, and Standard TCP/IP Printing).

The printing apparatus 220 receives a second packet 740 including the IP address (192.168.100.101) and the LPD data from the host 210 by using an LPD protocol.

The printing apparatus 220 permits an LPD service since the received IP address (192.168.100.101) included in the second packet 740 is also included in the user information 710 as an IP address of the user authentication information 730, and the LPD service corresponding to the LPD data of the second packet is one of the permissible services of the user authentication information 730.

According to aspects of the present invention, user authentication information is generated by performing user authentication that uses a protocol supporting user authentication. Then, when a service is requested using a protocol that does not support user authentication, it is determined whether the service is to be permitted by using the generated user authentication information. Accordingly, even when a service using a protocol that does not support user authentication is requested, the service can be selectively provided by identifying a user.

Aspects of the present invention can also be embodied as computer-readable codes on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A user authentication method comprising:
performing a user authentication using user information transmitted by a host through a protocol supporting user authentication;
generating user authentication information from the transmitted user information if the user authentication is performed successfully; and
determining whether a service requested from the host using a protocol that does not support user authentication is permitted by using the generated user authentication information.

2. The method as claimed in claim 1, wherein the generated user authentication information comprises at least one from among the transmitted user information, an IP address of the host, and a plurality of permissible service items.

3. The method as claimed in claim 1, wherein the performing of the user authentication comprises:
receiving the user information from the host by using the protocol supporting the user authentication; and
determining whether the received user information is previously stored, such that the user authentication is performed successfully if the received user information is previously stored.

4. The method as claimed in claim 3, wherein the performing of the user authentication further comprises:
transmitting a user authentication success message to the host when the received user information is previously stored.

5. The method as claimed in claim 3, wherein the performing of the user authentication further comprises:
transmitting a user authentication failure message to the host when the received user information is not previously stored.

6. The method as claimed in claim 1, wherein the determining of whether the requested service is permitted comprises:
receiving, from the host, data including a request for the service and an IP address of the host by using the protocol that does not support user authentication;
determining whether the IP address of the host included in the received data is included in the generated user authentication information; and
permitting the requested service when the IP address of the host is determined to be included in the generated user authentication information.

7. The method as claimed in claim 6, further comprising:
transmitting, to the host, a message rejecting the requested service when the IP address of the host is determined not to be included in the generated user authentication information.

8. The method as claimed in claim 1, wherein the determining of whether the requested service is permitted comprises:
receiving, from the host, data including a request for the service and an IP address of the host by using the protocol that does not support user authentication;
determining whether the IP address of the host included in the received data is included in the generated user authentication information;
determining whether the requested service included in the received data is included in the generated user authentication information; and
permitting the requested service when the IP address of the host is determined to be included in the generated user authentication information and the requested service is determined to be included in the generated user authentication information.

9. The method as claimed in claim 1, further comprising:
removing the user authentication information after a predetermined period of time has elapsed after the generating of the user authentication information.

10. The method as claimed in claim 2, further comprising:
removing the requested service from the permissible service items of the generated user authentication information if the requested service is determined to be permitted.

11. The method as claimed in claim 2, wherein the determining of whether the requested service is permitted comprises:
receiving, from the host, data including a request for the service and an IP address of the host by using the protocol that does not support user authentication;
determining whether the IP address of the host included in the received data is included in the generated user authentication information;
determining whether the requested service included in the received data is included in the plurality of permissible service items of the generated user authentication information; and
permitting the requested service when the IP address of the host is determined to be included in the generated user authentication information and the requested service is determined to be included in the plurality of permissible service items of the generated user authentication information.

12. A computer-readable medium recording a program for performing the method of claim 1 in a computer.

13. A user authentication apparatus comprising:
an interface unit to connect to a host through a network;
a user authentication unit to perform a user authentication using user information received from the host through a protocol supporting user authentication;
an authentication information generating unit to generate user authentication information from the transmitted user information if the user authentication is performed successfully; and
a service managing unit to determine whether a service requested from the host using a protocol that does not support user authentication is permitted by using the generated user authentication information.

14. The user authentication apparatus as claimed in claim 13, wherein the generated user authentication information comprises at least one from among the transmitted user information, an IP address of the host, and a plurality of permissible service items.

15. The user authentication apparatus as claimed in claim 13, wherein the user authentication unit performs the user authentication by determining whether the received user information is included in user information that is previously stored, such that the user authentication is performed successfully if the received user information is previously stored.

16. The user authentication apparatus as claimed in claim 13, wherein, when the interface unit receives, from the host by using the protocol that does not support user authentication, data including a request for the service and an IP address of the host, the service managing unit determines whether the IP address of the host included in the received data is included in the generated user authentication information and permits the requested service when the IP address of the host is determined to be included in the generated user authentication information.

17. The user authentication apparatus as claimed in claim 13, wherein, when the interface unit receives, from the host by using the protocol that does not support user authentication, data including a request for the service and an IP address of the host, the service managing unit determines whether the IP address of the host included in the received data is included in the generated user authentication information, determines whether the requested service included in the received data is included in the generated user authentication information, and permits the requested service when the IP address of the host is determined to be included in the generated user authentication information and the requested service is determined to be included in the generated user authentication information.

18. The user authentication apparatus as claimed in claim 13, wherein the authentication information generating unit removes the user authentication information after a predetermined period of time has elapsed after generating the user authentication information.

19. The user authentication apparatus as claimed in claim 14, wherein the authentication information generating unit removes the requested service from the permissible service items of the generated user authentication information if the requested service is determined to be permitted.

20. A system for performing a user authentication, the system comprising:
a host to transmit user information through a protocol supporting user authentication and to transmit data including a service request and an IP address of the host through a protocol that does not support user authentication; and
a user authentication apparatus comprising:
an interface unit to connect to the host through a network, to receive the user information transmitted from the host through the protocol supporting user authentication, and to receive the data including the service request transmitted from the host through the protocol that does not support user authentication;
a user authentication unit to perform a user authentication using the user information received from the host through the protocol supporting user authentication;
an authentication information generating unit to generate user authentication information from the received user information if the user authentication is performed successfully; and
a service managing unit to determine whether the service request received from the host is permitted by using the generated user authentication information.
